(19) United States
(12) Patent Application Publication
(10) Pub. No.: US 2020/0307557 A1
(43) Pub. Date: Oct. 1, 2020

(54) PARKING MANAGEMENT DEVICE, METHOD OF CONTROLLING PARKING MANAGEMENT DEVICE, AND STORAGE MEDIUM

(71) Applicant: HONDA MOTOR CO., LTD., Tokyo (JP)

(72) Inventors: Junpei Noguchi, Wako-shi (JP); Chie Sugihara, Tokyo (JP); Yuta Takada, Tokyo (JP); Ryoma Taguchi, Tokyo (JP)

(21) Appl. No.: 16/823,422

(22) Filed: Mar. 19, 2020

(30) Foreign Application Priority Data
Mar. 29, 2019 (JP) 2019-068977

(51) Int. Cl. B60W 30/06; G05D 1/00; B60W 60/00; G07B 15/02

(52) U.S. Cl. CPC B60W 30/06; G05D 1/0088; B60W 60/001; G05D 2201/0213; B60W 2556/45; B60W 2540/041; G07B 15/02

(57) ABSTRACT

A parking management device includes: a communicator configured to communicate with a vehicle and a terminal device of a user of the vehicle; a return manager configured to determine a sequence in which the vehicle arrives at a boarding area in which the user boards based on a position of the user recognized based on information acquired by the communicator, whether there is a return request of the vehicle from a parking lot which is acquired by the communicator, and coincidence between a time at which the return request of the vehicle is acquired and a return reservation time of the vehicle acquired in advance by the communicator; and a vehicle controller configured to transmit information which is used by a return target vehicle in autonomous traveling from the parking lot to the boarding area to the return target vehicle based on a sequence of the return target vehicle determined by the return manager.

### CROSS-REFERENCE TO RELATED APPLICATION

Priority is claimed on Japanese Patent Application No. 2019-068977, filed Mar. 29, 2019, the content of which is incorporated herein by reference.

### BACKGROUND

### Field of the Invention

The present invention relates to a parking management device, a method of controlling the parking management device, and a storage medium.

### Description of Related Art

In recent years, studies of automated vehicle control have been conducted. In automated valet parking performed using the studies, a technology for displaying whether a waiting space in which a vehicle waits at the time of boarding can be used for a driver has been disclosed (see Japanese Unexamined Patent Application, First Publication No. 2018-145655).

### SUMMARY

In the technology of the related art, a method of dispatching vehicles from a parking lot to a waiting space has not sufficiently been examined and users of the vehicles may not efficiently board the vehicles in some cases depending on the sequence of dispatch of the vehicles.

An aspect of the present invention is devised in view of such circumstances and an objective of the present invention is to provide a parking management device, a method of controlling the parking management device, and a storage medium capable of improving boarding efficiency of users of vehicles.

A parking management device, a method of controlling the parking management device, and a storage medium according to the present invention adopt the following configurations.

(1) According to an aspect of the present invention, a parking management device includes: a communicator configured to communicate with a vehicle and a terminal device of a user of the vehicle; a return manager configured to determine a sequence in which the vehicle arrives at a boarding area in which the user boards based on a position of the user recognized based on information acquired by the communicator, whether there is a return request of the vehicle from a parking lot which is acquired by the communicator, and coincidence between a time at which the return request of the vehicle is acquired and a return reservation time of the vehicle acquired in advance by the communicator; and a vehicle controller configured to cause the communicator to transmit information which is used by a return target vehicle in autonomous traveling from the parking lot to the boarding area to the return target vehicle based on a sequence of the return target vehicle determined by the return manager.

(2) In the parking management device according to the aspect (1), the return manager may advance a sequence in which a vehicle parked in the parking lot arrives at the boarding area as the coincidence between the acquisition time of the return request of the vehicle by the communicator and the return reservation time of the vehicle acquired in advance by the communicator is higher.

(3) In the parking management device according to the aspect (1), when the return request of the vehicle from the parking lot is acquired by the communicator, the return manager may advance a sequence in which the vehicle parked in the parking lot arrives at the boarding area than when the return request of the vehicle from the parking lot is not acquired by the communicator.

(4) In the parking management device according to the aspect (1), the return manager may advance a sequence in which the vehicle parked in the parking lot arrives at the boarding area as a relative distance between the position of the user recognized based on the information acquired by the communicator and a position of the parking lot is shorter.

(5) In the parking management device according to the aspect (1), a plurality of boarding positions may be in the boarding area. The vehicle controller may cause the communicator to transmit information which is used in autonomous traveling until a first boarding position to a first vehicle of which the sequence determined by the return manager is relatively earlier and cause the communicator to transmit information which is used in autonomous traveling until a second boarding position at which it is more difficult for the user to board than at the first boarding position to a second vehicle of which the sequence determined by the return manager is relatively later.

(6) In the parking management device according to the aspect (1), the parking management unit may impose a penalty on a user of the vehicle as a staying time of the vehicle in the boarding area is longer.

(7) In the parking management device according to the aspect (1), the parking management unit may cause the vehicle to perform autonomous traveling from the boarding area to the parking lot when the vehicle arriving at the boarding area is not allowed to board the user and a predetermined condition is established and impose a penalty on a user of the vehicle as the number of times the vehicle arrives at the boarding area from the parking lot until the vehicle enters and leaves from the parking lot is larger.

(8) According to another aspect of the present invention, there is provided a method of controlling a parking management device. The method causes a computer: to communicate with a vehicle and a terminal device of a user of the vehicle; to determine a sequence in which the vehicle arrives at a boarding area in which the user boards based on a position of the user recognized based on information acquired through communication with the vehicle or the terminal device, whether there is a return request of the vehicle from a parking lot acquired through communication with the vehicle or the terminal device, and coincidence between a time at which the return request of the vehicle is acquired and a return reservation time of the vehicle acquired in advance through communication with the vehicle or the terminal device; and to transmit information which is used by a return target vehicle in autonomous traveling from the parking lot to the boarding area to the return target vehicle based on a determined sequence of the return target vehicle.

(9) According to still another aspect of the present invention, a computer-readable non-transitory storage medium stores a program causing a computer to perform: a process of communicating with a vehicle and a terminal device of a user of the vehicle; a process of determining a sequence in which the vehicle arrives at a boarding area in which the user boards based on a position of the user recognized based on information acquired through communication with the vehicle or the terminal device, whether there is a return request of the vehicle from a parking lot acquired through communication with the vehicle or the terminal device, and coincidence between a time at which the return request of the vehicle is acquired and a return reservation time of the vehicle acquired in advance through communication with the vehicle or the terminal device; and a process of transmitting information which is used by a return target vehicle in autonomous traveling from the parking lot to the boarding area to the return target vehicle based on a determined sequence of the return target vehicle.

According to the aspects (1) and (9), it is possible to improve boarding efficiency of users of vehicles.

### BRIEF DESCRIPTION OF THE DRAWINGS

FIG. 1 is a diagram illustrating a configuration of a vehicle system.

FIG. 2 is a diagram illustrating a functional configuration of a first controller and a second controller.

FIG. 3 is a diagram schematically illustrating a scenario in which an autonomous parking event is performed.

FIG. 4 is a diagram illustrating an example of a configuration of a parking management device.

FIG. 5 is a diagram illustrating an example of a parking space state table.

FIG. 6 is a diagram illustrating an example of a parking reservation table.

FIG. 7 is a diagram illustrating an example of a priority table.

FIG. 8 is a diagram illustrating an example of assignment of priority to a vehicle.

FIG. 9 is a diagram schematically illustrating a scenario in which the autonomous parking event is performed.

FIG. 10 is a flowchart illustrating a flow of a series of processes of the parking management device according to an embodiment.

FIG. 11 is a flowchart illustrating a flow of a series of processes of the parking management device according to the embodiment.

FIG. 12 is a diagram illustrating an example of a hardware configuration of an automated driving control device according to an embodiment.

### DESCRIPTION OF EMBODIMENTS

Hereinafter, an embodiment of a parking management device, a method of controlling the parking management device, and a storage medium according to the present invention will be described with reference to the drawings. Hereinafter, an embodiment in which a parking management target by the parking management device is an automated driving vehicle will be described as an example. In automated driving, for example, one or both of steering and acceleration or deceleration of a vehicle is controlled automatically and driving control is performed. For an automated driving vehicle, driving control may be performed through a manual operation by a user.

### [Overall Configuration]

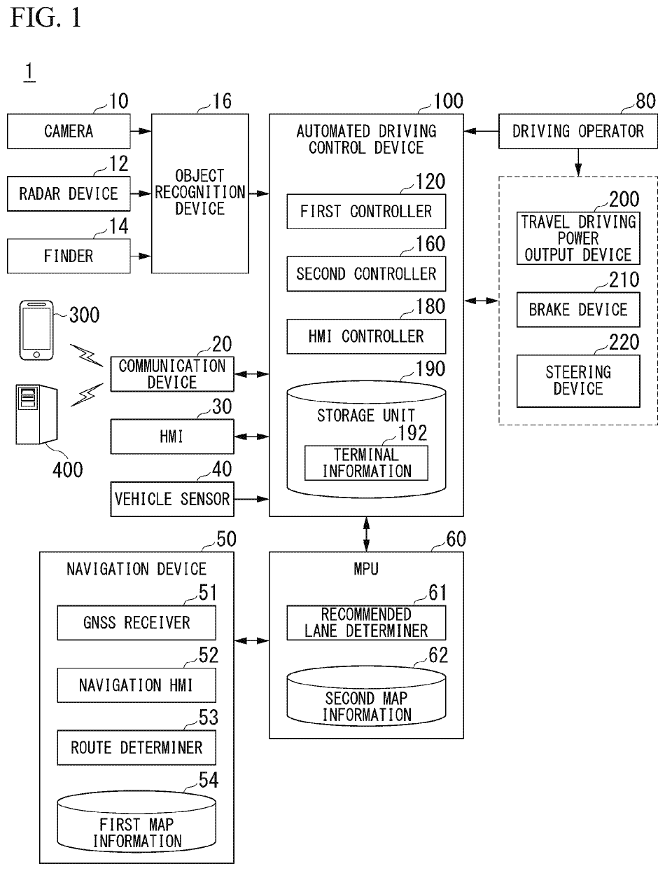

FIG. 1 is a diagram illustrating a configuration of a vehicle system 1. A vehicle in which the vehicle system 1 is mounted is, for example, a vehicle such as a two-wheeled vehicle, a three-wheeled vehicle, or a four-wheeled vehicle. A driving source of the vehicle includes an internal combustion engine such as a diesel engine, a gasoline engine, or a hydrogen engine, an electric motor, and a combination thereof. The electric motor operates using power generated by a power generator connected to the internal combustion engine or power discharged from battery (a secondary battery) such as a secondary cell or a fuel cell.

The vehicle system 1 includes, for example, a camera 10, a radar device 12, a finder 14, an object recognition device 16, a communication device 20, a human machine interface (HMI) 30, a vehicle sensor 40, a navigation device 50, a map positioning unit (MPU) 60, a driving operator 80, an automated driving control device 100, a travel driving power output device 200, a brake device 210, and a steering device 220. The devices and units are connected to one another via a multiplex communication line such as a controller area network (CAN) communication line, a serial communication line, or a wireless communication network. The configuration shown in FIG. 1 is merely exemplary, a part of the configuration may be omitted, and another configuration may be further added.

The camera 10 is, for example, a digital camera that uses a solid-state image sensor such as a charged coupled device (CCD) or a complementary metal oxide semiconductor (CMOS). The camera 10 is mounted on any portion of a vehicle in which the vehicle system 1 is mounted (hereinafter referred to as a vehicle M). For example, when the camera 10 images a front side, the camera 10 is mounted on an upper portion of a front windshield, a rear surface of a rearview mirror, and the like. For example, the camera 10 repeatedly images the surroundings of the vehicle M periodically. The camera 10 may be a stereo camera.

The radar device 12 radiates radio waves such as millimeter waves to the surroundings of the vehicle M and detects radio waves (reflected waves) reflected from an object to detect at least a position (a distance and an azimuth) of the object. The radar device 12 is mounted on any portion of the vehicle M. The radar device 12 may detect a position and a speed of an object in conformity with a frequency modulated continuous wave (FM-CW) scheme.

The finder 14 is a light detection and ranging (LIDAR) finder. The finder 14 radiates light to the surroundings of the vehicle M and measures scattered light. The finder 14 detects a distance to a target based on a time from light emission to light reception. The radiated light is, for example, pulsed laser light. The finder 14 is mounted on any portions of the vehicle M.

The object recognition device 16 performs a sensor fusion process on detection results from some or all of the camera 10, the radar device 12, and the finder 14 and recognizes a position, a type, a speed, and the like of an object. The object recognition device 16 outputs a recognition result to the automated driving control device 100. The object recognition device 16 may output detection results of the camera 10, the radar device 12, and the finder 14 to the automated driving control device 100 without any change. The object recognition device 16 may be excluded from the vehicle system 1.

The communication device 20 communicates with, for example, the terminal device 300 used by a user of the vehicle M, other vehicles around the vehicle M, a parking management device 400, or various server devices, for example, using a network such as a cellular network, a Wi-Fi network, Bluetooth (registered trademark), or dedicated short range communication (DSRC). The terminal device 300 is, for example, a portable terminal such as a smartphone or a tablet terminal carried by the user, but the present invention is not limited thereto. The terminal device 300 may be a management terminal, a server device, or the like used by a preset manager or the like. Hereinafter, the terminal device 300 is assumed to be a portable terminal carried by the user in the description.

The HMI 30 presents various types of information to a user of the vehicle M and receives input operations by the user. The HMI 30 includes a display device, a speaker, a buzzer, a touch panel, a switch, and a key. The display device includes, for example, a meter display provided in a portion facing a driver in an instrument panel, a center display provided in the middle of the instrument panel, and a head-up display (HUD). The HUD is, for example, a device that enables the user to view an image overlapping a landscape. For example, the HUD enables a user to view a virtual image by projecting light including an image to the front windshield or a combiner of the vehicle M.

The vehicle sensor 40 includes a vehicle speed sensor that detects a speed of the vehicle M, an acceleration sensor that detects acceleration, a yaw rate sensor that detects angular velocity around a vertical axis, and an azimuth sensor that detects a direction of the vehicle M. The vehicle sensor 40 may include a load sensor that detects a load applied to a sheet in the vehicle. A result detected by the vehicle sensor 40 is output to the automated driving control device 100.

The navigation device 50 includes, for example, a global navigation satellite system (GNSS) receiver 51, a navigation HMI 52, and a route determiner 53. The navigation device 50 retains first map information 54 in a storage device such as a hard disk drive (HDD) or a flash memory. The GNSS receiver 51 specifies a position of the vehicle M based on signals received from GNSS satellites. The position of the vehicle M may be specified or complemented by an inertial navigation system (INS) using an output of the vehicle sensor 40. The navigation HMI 52 includes a display device, a speaker, a touch panel, and a key. The navigation HMI 52 may be partially or entirely common to the above-described HMI 30. The route determiner 53 determines, for example, a route from a position of the vehicle M specified by the GNSS receiver 51 (or any input position) to a destination input by a user using the navigation HMI 52 (hereinafter referred to as a route on a map) with reference to the first map information 54. The first map information 54 is, for example, information in which a road shape is expressed by links indicating roads and nodes connected by the links. The first map information 54 may include curvatures of roads and point of interest (POI) information. The route on the map is output to the MPU 60. The navigation device 50 may perform route guidance using the navigation HMI 52 based on the route on the map. The navigation device 50 may be realized by, for example, a function of the terminal device 300 of the user. The navigation device 50 may transmit a present position and a destination to a navigation server via the communication device 20 to acquire the same route as the route on the map from the navigation server. The navigation device 50 outputs the determined route on the map to the MPU 60.

The MPU 60 includes, for example, a recommended lane determiner 61 and retains second map information 62 in a storage device such as an HDD or a flash memory. The recommended lane determiner 61 divides the route on the map provided from the navigation device 50 into a plurality of blocks (for example, divides the route in a vehicle movement direction for each 100 [m]) and determines a recommended lane for each block with reference to the second map information 62. The recommended lane determiner 61 determines in which lane the vehicle travels from the left. When there is a branching location in the route on the map, the recommended lane determiner 61 determines a recommended lane so that the vehicle M can travel in a reasonable route to move to a branching destination.

The second map information 62 is map information that has higher precision than the first map information 54. The second map information 62 includes, for example, information regarding the middles of lanes or information regarding boundaries of lanes. The second map information 62 may include road information, traffic regulation information, address information (address and postal number), facility information, parking lot information, and telephone number information. The parking lot information is, for example, the position or shape of a parking space in which a vehicle is parked, a parkable number, whether to perform manned driving, whether to perform unmanned driving, or the like. The second map information 62 may be updated frequently by communicating with another device using the communication device 20.

The driving operator 80 includes, for example, an accelerator pedal, a brake pedal, a shift lever, a steering wheel, a steering variant, a joystick, and other manipulators. A sensor that detects whether there is a manipulation or a manipulation amount is mounted on the driving operator 80. A detection result is output to the automated driving control device 100 or some or all of the travel driving power output device 200, the brake device 210, and the steering device 220.

The automated driving control device 100 includes, for example, a first controller 120, a second controller 160, an HMI controller 180, and a storage unit 190. Each of the first controller 120, the second controller 160, and the HMI controller 180 is realized, for example, by causing a hardware processor such as a central processing unit (CPU) to execute a program (software). Some or all of the constituent elements may be realized by hardware (a circuit unit including circuitry) such as a large scale integration (LSI), an application specific integrated circuit (ASIC), a field-programmable gate array (FPGA), or a graphics processing unit (GPU) or may be realized by software and hardware in cooperation. The program may be stored in advance in a storage device (a storage device including a non-transitory storage medium) such as an HDD or a flash memory of the automated driving control device 100 or may be stored in a storage medium (a non-transitory storage medium) detachably mounted on a DVD, a CD-ROM, or the like so that the storage medium is mounted on a drive device to be installed on the HDD or the flash memory of the automated driving control device 100.

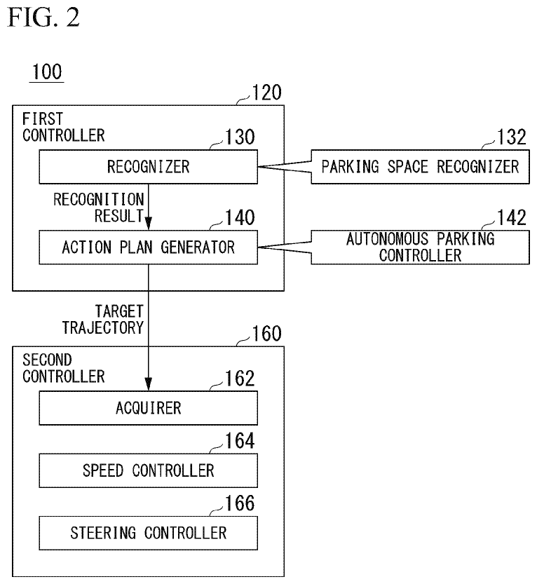

FIG. 2 is a diagram illustrating a functional configuration of the first controller 120 and the second controller 160. The first controller 120 includes, for example, a recognizer 130 and an action plan generator 140. The first controller 120 realizes, for example, a function by artificial intelligence (AI) and a function by a model given in advance in parallel. For example, a function of “recognizing an intersection” may be realized by performing recognition of an intersection by deep learning or the like and recognition based on a condition given in advance (a signal, a road sign, or the like which can be subjected to pattern matching) in parallel, scoring both the recognitions, and performing evaluation comprehensively. Thus, reliability of automated driving is guaranteed.

The recognizer 130 recognizes states such as a position, a speed, acceleration, or the like of an object near the vehicle M based on information input from the camera 10, the radar device 12, and the finder 14 via the object recognition device 16. For example, the position of the object is recognized as a position on the absolute coordinates in which a representative point (a center of gravity, a center of a driving shaft, or the like) of the vehicle M is the origin and is used for control. The position of the object may be represented as a representative point such as a center of gravity, a corner, or the like of the object or may be represented as expressed regions. A “state” of an object may include acceleration or jerk of the object or an “action state” (for example, whether a vehicle is changing a lane or is attempting to change the lane).

The recognizer 130 recognizes, for example, a lane in which the vehicle M is traveling (a travel lane). For example, the recognizer 130 recognizes the travel lane by comparing patterns of road mark lines (for example, arrangement of continuous lines and broken lines) obtained from the second map information 62 with patterns of road mark lines around the vehicle M recognized from images captured by the camera 10. The recognizer 130 may recognize a travel lane by mainly recognizing runway boundaries (road boundaries) including road mark lines or shoulders, curbstones, median strips, and guardrails without being limited to road mark lines. In this recognition, the position of the vehicle M acquired from the navigation device 50 or a process result by INS may be added. The recognizer 130 recognizes temporary stop lines, obstacles, red signals, toll gates, entrance gates of parking lots, and other road events.

The recognizer 130 recognizes a position or a posture of the vehicle M with respect to the travel lane when the recognizer 130 recognizes the travel lane. For example, the recognizer 130 may recognize a deviation from the middle of a lane of a standard point of the vehicle M and an angle formed with a line extending along the middle of a lane and the travel direction of the vehicle M as a relative position and posture of the vehicle M to the travel lane. Instead of this, the recognizer 130 may recognize a position or the like of the standard point of the vehicle M with respect to a side end portion (a road mark line or a road boundary) of any travel lane as the relative position of the vehicle M to the travel lane.

The recognizer 130 includes a parking space recognizer 132 that is activated in an autonomous parking event to be described below. The details of the function of the parking space recognizer 132 will be described later.

The action plan generator 140 generates a target trajectory along which the vehicle M travels in future automatically (irrespective of an operation of a driver or the like) so that the vehicle M is traveling along a recommended lane determined by the recommended lane determiner 61 and handles a surrounding situation of the vehicle M in principle. The target trajectory includes, for example, a speed component. For example, the target trajectory is expressed by arranging spots (trajectory points) at which the vehicle M will arrive in sequence. The trajectory point is a spot at which the vehicle M will arrive for each predetermined travel distance (for example, about several [m]) in a distance along a road. Apart from the trajectory points, target acceleration and a target speed are generated as parts of the target trajectory for each of predetermined sampling times (for example, about a decimal point of a second). The trajectory point may be a position at which the vehicle M will arrive at the sampling time for each predetermined sampling time. In this case, information regarding the target acceleration or the target speed is expressed according to an interval between the trajectory points.

The action plan generator 140 may set an automated driving event when the target trajectory is generated. As the automated driving event, there are a constant speed traveling event, a low speed track traveling event, a lane changing event, a branching event, a joining event, a takeover event, an autonomous parking event in which a vehicle performs automated traveling and parks in a parking lot of valet parking or the like, and the like. The automated traveling is traveling performed through automated driving. The automated traveling includes, for example, unmanned traveling. The action plan generator 140 generates the target trajectory in accordance with an activated event. The action plan generator 140 includes an autonomous parking controller 142 that is activated when an autonomous parking event is performed. The details of a function of the autonomous parking controller 142 will be described later.

The second controller 160 controls the travel driving power output device 200, the brake device 210, and the steering device 220 so that the vehicle M passes along the target trajectory generated by the action plan generator 140 at a scheduled time. The second controller 160 includes, for example, an acquirer 162, a speed controller 164, and a steering controller 166. The acquirer 162 acquires information regarding the target trajectory (trajectory points) generated by the action plan generator 140 and stores the information in a memory (not illustrated). The speed controller 164 controls the travel driving power output device 200 or the brake device 210 based on a speed element incidental to the target trajectory stored in the memory. The steering controller 166 controls the steering device 220 in accordance with a curve state of the target trajectory stored in the memory. Processes of the speed controller 164 and the steering controller 166 are realized, for example, by combining feed-forward control and feedback control. For example, the steering controller 166 performs the feed-forward control in accordance with a curvature of a road in front of the vehicle M and the feedback control based on separation from the target trajectory in combination.

Referring back to FIG. 1, the HMI controller 180 notifies a user of predetermined information through the HMI 30. The predetermined information is, for example, information regarding travel of the vehicle M, such as information regarding a state of the vehicle M or information regarding driving control. The information regarding the state of the vehicle M includes, for example, a speed, an engine speed, a shift position, or the like of the vehicle M. The information regarding the driving control includes, for example, information regarding whether to perform the automated driving or information regarding the degree of driving support through the automated driving. The predetermined information may include information not associated with travel of the vehicle M, such as a television program or content (for example, a movie) stored in a storage medium such as DVD. The HMI controller 180 may output the information received by the HMI 30 to the communication device 20, the navigation device 50, the first controller 120, and the like.

The HMI controller 180 may communicate with the terminal device 300 via the communication device 20 and output information acquired from the terminal device 300 to the HMI 30. The HMI controller 180 may causes a display device of the HMI 30 to display a registration screen for registering the terminal device 300 communicating with the vehicle M and acquires information (for example, address information) regarding the registration of the terminal device 300 input to an input device of the HMI 30 in accordance with the registration screen. The HMI controller 180 may perform control such that the acquired information regarding the registration of the terminal device 300 is stored in the terminal information 192. The terminal device 300 gives an entrance instruction, a return instruction, or the like to the vehicle M, for example, when the vehicle M is caused to enter or return from a parking area through automated driving in accordance with an autonomous parking event (when autonomous parking is performed). The registration of the above-described terminal device 300 is performed, for example, at a predetermined timing when the user boards or before the autonomous parking starts. The above-described registration of the terminal device 300 is performed in accordance with an application program (a vehicle cooperation application to be described below) installed in the terminal device 300.

The storage unit 190 is realized by, for example, an HDD, a flash memory, an EEPROM, a read-only memory (ROM), a random access memory (RAM), or the like. In the storage unit 190, for example, the terminal information 192 and other information are stored.

For example, when the own vehicle M is an automobile that has an internal combustion as a power source, the travel driving power output device 200 includes an engine and an engine electronic control unit (ECU) that controls the engine. The ECU adjusts the degree of throttle opening, a shift stage, or the like of the engine in accordance with information input from the second controller 160 or information input from the driving operator 80 and outputs a travel driving power (torque) for traveling the vehicle M.

The brake device 210 includes, for example, a brake caliper, a cylinder that transmits a hydraulic pressure to the brake caliper, an electronic motor that generates a hydraulic pressure to the cylinder, and a brake ECU. The brake ECU controls the electric motor in accordance with information input from the second controller 160 or information input from the driving operator 80 such that a brake torque in accordance with a brake operation is output to each wheel. The brake device 210 may include a mechanism that transmits a hydraulic pressure generated in response to an operation of the brake pedal included in the driving operator 80 to the cylinder via a master cylinder as a backup. The brake device 210 is not limited to the above-described configuration and may be an electronic control type hydraulic brake device that controls an actuator in accordance with information input from the second controller 160 such that a hydraulic pressure of the master cylinder is transmitted to the cylinder.

The steering device 220 includes, for example, a steering ECU and an electric motor. The electric motor works a force to, for example, a rack and pinion mechanism to change a direction of a steering wheel. The steering ECU drives the electric motor to change the direction of the steering wheel in accordance with information input from the second controller 160 or information input from the driving operator 80.

Next, driving control of the vehicle M according to the embodiment will be described specifically. Hereinafter, a scenario in which the vehicle M performs autonomous parking through unmanned traveling in a valet parking of a facility to be visited will be described as an example of a scenario in which the vehicle M performs driving control.

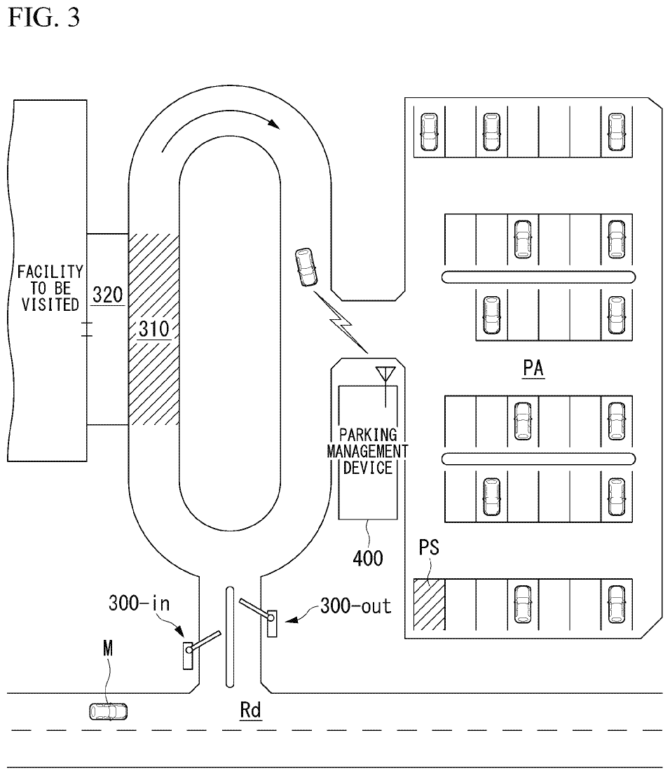

FIG. 3 is a diagram schematically illustrating a scenario in which an autonomous parking event is performed according to the embodiment. In the example of FIG. 3, a parking area (for example, a valet parking area) PA of the facility to be visited is illustrated. The parking area PA is, for example, an area in which a vehicle can be caused to travel or park through automated driving. The parking area PA is assumed to be, for example, a region in which a vehicle can travel through unmanned traveling or manned traveling and a region in which a user of a vehicle is permitted to pass. The manned traveling includes, for example, traveling through manual driving or traveling through automated driving in a state in which a user boards.

In the parking area PA, for example, a gate 300-in, a gate 300-out, a boarding area 310, and a waiting area 320 are provided in a route from a road Rd to the facility to be visited. In the example of FIG. 3, a parking management device 400 that manages a parking situation of the parking area PA and transmits a vacant situation or the like to a vehicle is assumed to be provided.

Here, processes at the time of entrance and return of the vehicle M in accordance with an autonomous parking event of the autonomous parking controller 142 will be described.

### [Autonomous Parking Event: At Time of Entrance]

The autonomous parking controller 142 causes the vehicle M to park in a parking space of the parking area PA based on, for example, information acquired by the communication device 20 from the parking management device 400. In this case, the vehicle M passes through the gate 300-in and enters the boarding area 310 through manual driving or automated driving. The boarding area 310 includes a plurality of boarding positions and faces the waiting area 320 connected to the facility to be visited. In the waiting area 320, an eave is provided to block rain and snow.

After a user gets out of the vehicle in the boarding area 310, the vehicle M performs automated driving and starts an autonomous parking event for moving to a parking space PS in the parking area PA. A trigger to start the autonomous parking event may be, for example, any operation (for example, an entrance instruction from the terminal device 300) by the user or may be wireless reception of a predetermined signal from the parking management device 400. When the autonomous parking event starts, the autonomous parking controller 142 controls the communication device 20 such that a parking request is transmitted to the parking management device 400. Then, the vehicle M moves in accordance with guidance of the parking management device 400 or moves while performing sensing by itself from the boarding area 310 to the parking area PA.

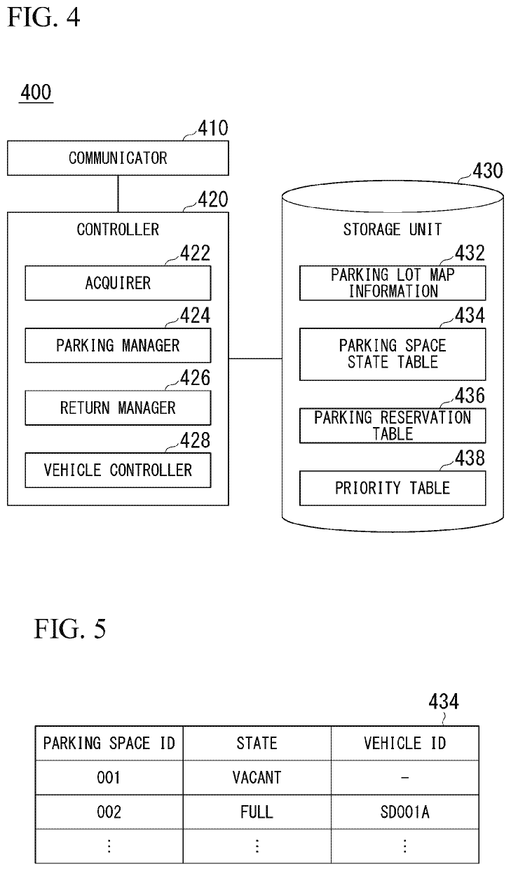

FIG. 4 is a diagram illustrating an example of a configuration of the parking management device 400. The parking management device 400 includes, for example, a communicator 410, a controller 420, and a storage unit 430. The controller 420 includes, for example, an acquirer 422, a parking manager 424, a return manager 426, and a vehicle controller 428. The storage unit 430 stores information such as parking lot map information 432, a parking space state table 434, a parking reservation table 436, and a priority table 438.

The communicator 410 wirelessly communicates with the vehicle M and the terminal device 300. The controller 420 guides the vehicle to the parking space PS based on information acquired by the communicator 410 and information stored in the storage unit 430. The parking lot map information 432 is information that geometrically represents a structure of the parking area PA. The parking lot map information 432 includes coordinates of each parking space PS.

The acquirer 422 acquires information used when the position of a user is recognized, reservation information of return of a vehicle from the parking lot, and information regarding whether a request for returning the vehicle from the parking lot is made by using the communicator 410 from the terminal device 300 carried by the user. The information used when the position of the user is recognized may be, for example, positional information of the terminal device 300 or may be distance information between the terminal device 300 and the parking lot.

The parking manager 424 manages parking positions of vehicles in the parking lot with reference to the parking space state table 434.

As illustrated in FIG. 5, in the parking space state table 434, for example, a state which indicates a vacant state and a full (parking) state and a vehicle ID which is identification information of a vehicle parked in the case of the full state are associated with a parking space ID which is identification information of the parking space PS.

When the communicator 410 receives a parking request from a vehicle, the parking manager 424 extracts the parking space (a vacant space) PS of which a state is a vacant state with reference to the parking space state table 434, acquires a position of the extracted parking space PS from the parking lot map information 432, and transmits a suitable route to the acquired position of the parking space PS to the vehicle through the communicator 410. The parking manager 424 instructs a specific vehicle to stop or move slowly, as necessary, based on a positional relation between a plurality of vehicles so that the vehicles do not simultaneously advance to the same positions.

In a vehicle receiving the route (hereinafter assumed to be the vehicle M), the autonomous parking controller 142 generates a target trajectory based on the route. When the vehicle M approaches the parking space PS which is a target, the parking space recognizer 132 recognizes parking frame lines or the like marking the parking space PS, recognizes a detailed position of the parking space PS, and supplies the detailed position of the parking space PS to the autonomous parking controller 142. The autonomous parking controller 142 receives the detailed position of the parking space PS, corrects the target trajectory, and parks the vehicle M in the parking space PS.

The present invention is not limited to the above description, and the autonomous parking controller 142 may find an empty parking space by itself based on a detection result by the camera 10, the radar device 12, the finder 14, or the object recognition device 16 irrespective of communication and may cause the vehicle M to park in the found parking space.

The return manager 426 registers reservation information of return of the vehicle from the parking lot acquired by the acquirer 422 in the parking reservation table 436 of the storage unit 430. In the parking reservation table 436, reservation information registered in advance is updated when the reservation information of the return of the vehicle from the parking lot is registered.

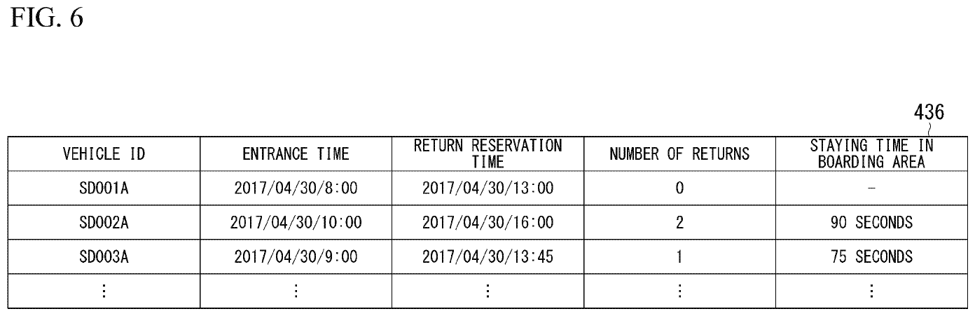

As illustrated in FIG. 6, in the parking reservation table 436, for example, an entrance time of a vehicle to the parking lot, a return reservation time of the vehicle from the parking lot, the number of returns of the vehicle from the parking lot, and a staying time of the vehicle in the boarding area are associated with a vehicle ID which is identification information of the vehicle. The entrance time is recorded in association with the vehicle ID at the time of entrance of the vehicle to the parking lot. The return reservation time is recorded in association with the vehicle ID at the time of reception of a parking reservation of the vehicle. The number of returns is the number of times that a return-requested vehicle arrives at the boarding area 310 for a period from entrance to the parking lot to exit from the parking lot. The staying time of the vehicle is a time in which the user boards the vehicle arriving at the boarding area 310 or cargos are loaded and unloaded on this vehicle.

The return manager 426 determines a sequence in which vehicles parked in the parking lot arrive at the boarding area 310 with reference to the priority table 438. In the priority table 438, a method of setting priority for determining the sequence of the arrival at the boarding area 310 is defined.

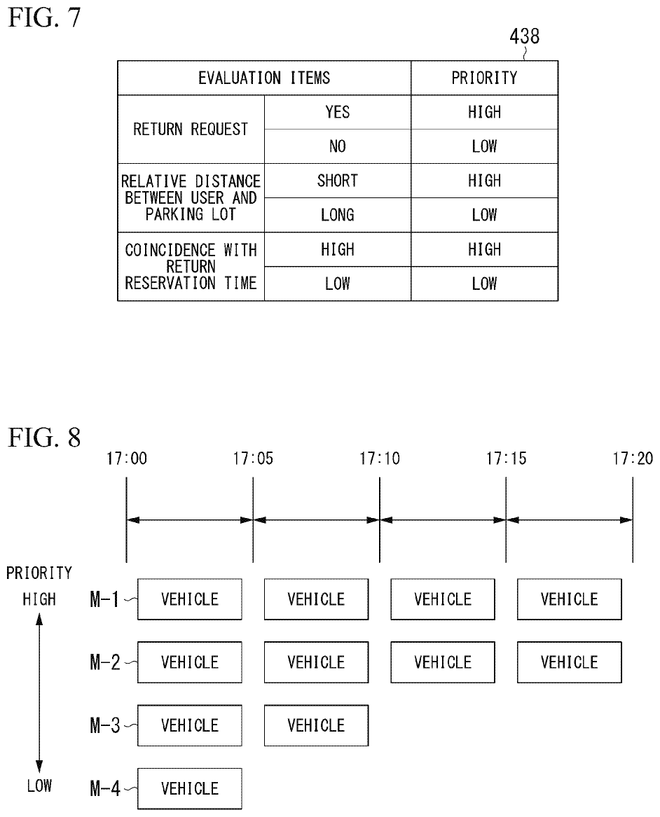

As illustrated in FIG. 7, in the priority table 438, for example, presence or absence of a return request of a vehicle from the parking lot, a relative distance between a user and the parking lot (boarding zone), and coincidence between a return reservation time of a vehicle from the parking lot and a time at which a return of the vehicle from the parking lot is requested are associated with priority used when the sequence of the vehicles from the parking lot is determined. In the example illustrated in the drawing, when the return request of the vehicle from the parking lot is given, the priority is set to be higher than when the return request of the vehicle from the parking lot is not given. In this example, when the relative distance between the user and the parking lot is less than a predetermined value (classified as “Short”), the priority is set to be higher than when the relative distance between the user and the parking lot is equal to or greater than a predetermined value (classified as “Long”). In this example, when the coincidence between a return reservation time of a vehicle from the parking lot and a time at which a request of the vehicle from the parking lot is requested is equal to or greater than a predetermined value (classified as “High”), the priority is set to be higher than when the coincidence between a return reservation time of a vehicle from the parking lot and a time at which a return of the vehicle from the parking lot is requested is less than a predetermined value (classified as “Low”).

When a vehicle to which the return is requested is included or a vehicle in which a return reservation condition is established is included in the vehicles parked in the parking lot, the return manager 426 determines this vehicle as a return target. That is, in the embodiment, when the return reservation condition is established irrespective of whether a return of a vehicle is requested, the return manager 426 determines this vehicle as a return target. The return reservation condition is established, for example, when a current time coincides with the return reservation time. However, not only when the current time coincides with the return reservation time but also when a time difference between the current time and the return reservation time is within a predetermined range, the return reservation condition may be established. When the number of return target vehicles is plural, the return manager 426 sets priority of each of the plurality of vehicles with reference to the priority table 438. Then, the return manager 426 determines a sequence in which the vehicles parked in the parking lot arrive at the boarding area 310 so that vehicles in which relatively higher priority is set arrive at the boarding area 310 earlier than vehicles in which relatively lower priority is set.

When a vehicle to which the return is requested or a vehicle in which a return reservation condition is established is included in the vehicles parked in the parking lot, the vehicle controller 428 determines this vehicle as a return target. Then, the vehicle controller 428 causes the communicator 410 to transmit information which the return target vehicle uses in autonomous traveling from the parking lot to the boarding area 310 to the vehicle M. When the number of return target vehicles is plural, the vehicle controller 428 assigns a predetermined boarding position to each return target vehicle among a plurality of boarding positions included in the boarding area 310. In this case, the vehicle controller 428 assigns a first boarding position to a first vehicle of which the sequence determined as the return target by the return manager 426 is relatively earlier and assigns a second boarding position at which it is more difficult for the user to board than at the first boarding position to a second vehicle of which the sequence determined by the return manager 426 is relatively later. Then, the vehicle controller 428 causes the communicator 410 to transmit information which is used in autonomous traveling to the assigned boarding position to the vehicle M.

When the return target vehicle arrives at the boarding area 310, the vehicle controller 428 starts clocking a staying time of the vehicle. Then, when the communicator 410 receives, for example, a signal indicating launch from the boarding area 310 from the vehicle M, the vehicle controller 428 registers the clocked staying time of the vehicle in the parking reservation table 436. When the vehicle arrives at the boarding area 310 without requesting the return of the vehicle, an occupant does not boards, and a predetermined condition is established, the vehicle controller 428 causes the communicator 410 to transmit information which is used in autonomous traveling from the boarding area 310 to the parking lot to the vehicle M. In this case, the vehicle controller 428 resets the clocked staying time of the vehicle. As the predetermined condition, for example, a condition that the staying time of the vehicle in the boarding area 310 reaches a predetermined threshold can be exemplified. In this case, the predetermined threshold is set based on, for example, a statistical value (an average value, a median value, a mode, or the like) of the staying times from arrival of the vehicle at the boarding area 310 to launch.

When the return is requested to a vehicle performing the autonomous traveling to the parking lot, the vehicle controller 428 causes the communicator 410 to transmit information which the vehicle uses in autonomous traveling from the parking lot to the boarding area 310 to the vehicle M. In this case, whenever the vehicle M is returned from the parking lot, the vehicle controller 428 updates the number of returns of the vehicle and registers the updated number of returns in the parking reservation table 436.

Incidentally, when a user does not quickly board the vehicle arriving at the boarding area 310 or it takes excessive time to load and unload cargos, entrance and exit of other vehicles to and from the parking lot are hindered in some cases. Therefore, the vehicle controller 428 imposes a penalty on this vehicle with reference to the parking reservation table 436. The penalty is a condition that it is difficult to for a user to use a parking lot and examples of the penalty include a penalty of fine and an extra charge of a usage fee of the parking lot from the next time. For example, when the number of returns of the vehicle shown in the parking reservation table 436 is equal to or greater than a predetermined threshold or the staying time of the vehicle in the boarding area 310 is equal to or greater than a predetermined threshold, the vehicle controller 428 imposes a penalty on the user of the vehicle M.

FIG. 8 is a diagram illustrating an example of assignment of priority to the vehicle M. In the example illustrated in the drawing, return reservation times of the vehicles from the parking lot are classified in accordance with a predetermined period of time. A plurality of vehicles of which the return reservation time belong to the same period of time are targets to which the priority is assigned. In this example, assignment of the priority to four vehicles M-1 to M-4 belonging to periods of time from “17:00” to “17:05” will be described as an example. In this example, the return manager 426 sets the highest priority to the vehicle M-1, sets the second highest priority to the vehicle M-2, sets the third highest priority to the vehicle M-3, and sets the lowest priority to the vehicle M-4.

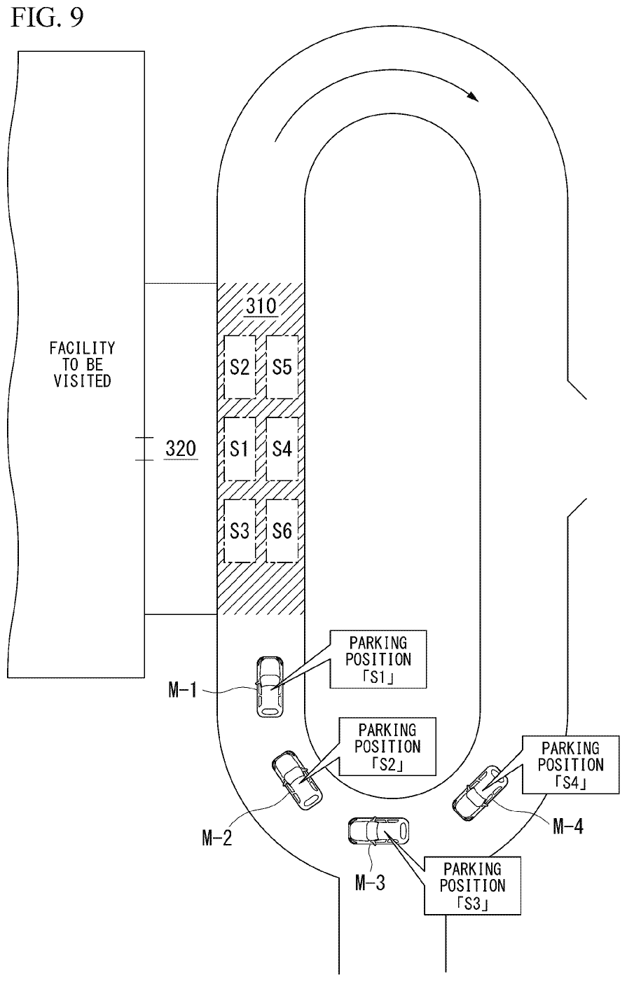

FIG. 9 is a diagram schematically illustrating a scenario in which the autonomous parking event is performed. In the example illustrated in the drawing, the vehicle controller 428 causes the vehicles M-1 to M-4 to perform autonomous traveling so that the vehicles travel from the front of a vehicle row in a higher priority sequence in accordance with the priority set by the return manager 426. The vehicle controller 428 assigns a boarding position S1 at which the user can board most easily to the vehicle M-1 to which the highest priority is set. The vehicle controller 428 assigns a boarding position S2 at which the user can board easily next to the boarding position S1 to the vehicle M-2 to which the second highest priority is set. The vehicle controller 428 assigns a boarding position S3 at which the user can board easily next to the boarding position S2 to the vehicle M-3 to which the third highest priority is set. The vehicle controller 428 assigns a boarding position S4 at which the user can board easily next to the boarding position S3 to the vehicle M-4 to which the lowest priority is set. The easiness of use of the boarding position is evaluated, for example, based on a distance from an entrance of a facility to be visited, a distance from the waiting area 320 in the boarding area 310, or the like.

### [Process Flow of Parking Management Device]

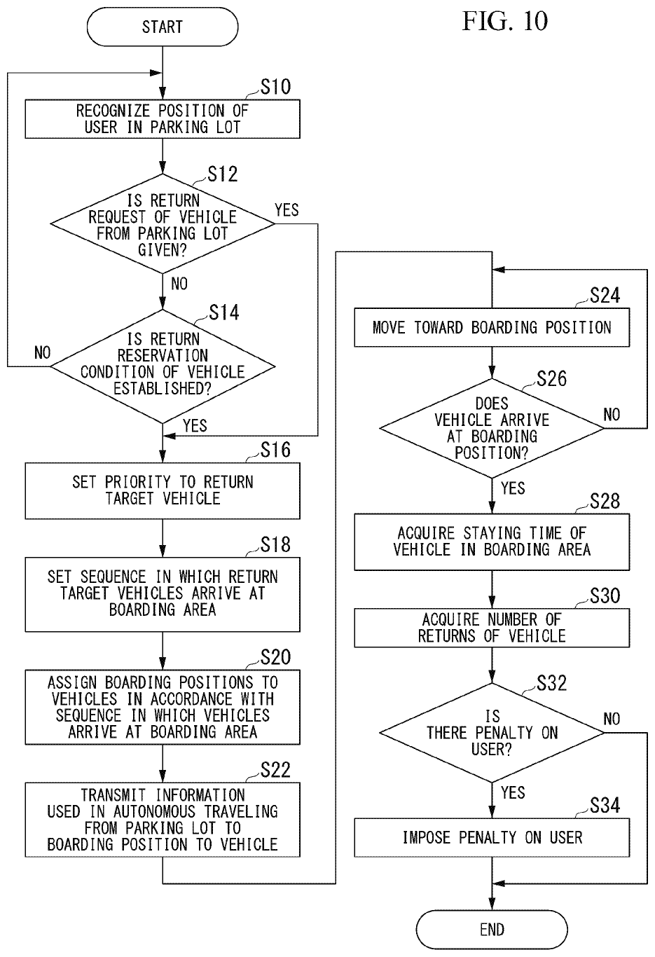

Hereinafter, a flow of a series of processes of the parking management device 400 according to an embodiment will be described with reference to a flowchart. FIG. 10 is a flowchart illustrating a flow of a series of processes of the parking management device 400 according to an embodiment. The processes of the flowchart may be repeated, for example, at a predetermined period.

First, the return manager 426 recognizes a position of the user based on information acquired by the acquirer 422 from the terminal device 300 carried by the user through the communicator 410 (step S10). Subsequently, based on the acquired information, the return manager 426 determines whether a return request of the vehicle from the parking lot is given (step S12). When the return manager 426 determines that the return request of the vehicle from the parking lot is given, the return manager 426 sets priority to a return target vehicle with reference to the priority table 438 (step S16). Conversely, when the return manager 426 determines that the return request of the vehicle from the parking lot is not given, the return manager 426 determines whether the return reservation condition of the vehicle is established with reference to the parking reservation table 436 (step S14). When the return manager 426 determines that the return reservation condition of the vehicle is not established, the return manager 426 returns the process to step S10. Conversely, when the return manager 426 determines that the return reservation condition of the vehicle is established, the return manager 426 sets priority to a return target vehicle with reference to the priority table 438 (step S16). Then, the return manager 426 determines a sequence in which the return target vehicles arrive at the boarding area 310 based on the set priority (step S18).

Subsequently, the return manager 426 assigns the banding positions in the boarding area 310 to the vehicles in accordance with the sequence in which the vehicles arrive at the boarding area 310 (step S20). In this case, the return manager 426 assigns the boarding position at which the user can board easily to the vehicle of which the sequence in which the vehicles arrive at the boarding area 310 is relatively earlier. Then, the vehicle controller 428 causes the communicator 410 to transmit information used in autonomous traveling to the boarding position assigned by the return manager 426 to the vehicle (step S22). Then, the vehicle controller 428 causes the vehicle to move to the assigned boarding position (step S24). Subsequently, the vehicle controller 428 determines whether the vehicle arrives at a predetermined boarding position based on information acquired from the vehicle by the communicator 410 (step S26). When the vehicle controller 428 determines that the vehicle arrives at the predetermined boarding position through communication with the vehicle by the communicator 410, the vehicle controller 428 acquires a staying time of the vehicle in the boarding area 310 (step S28). The vehicle controller 428 acquires the number of returns of the vehicle through communication with the vehicle by the communicator 410 (step S30). The vehicle controller 428 determines whether a penalty is imposed to the user of the vehicle based on the staying time of the vehicle in the boarding area 310 and the number of returns of the vehicle (step S32). Then, when the vehicle controller 428 determines that the penalty is imposed to the user of the vehicle, the penalty is imposed to the user (step S34). In this way, the process of the flowchart ends. Conversely, when the vehicle controller 428 determines that the penalty is not imposed to the user of the vehicle, the penalty is not imposed to the user and the process of the flowchart ends.

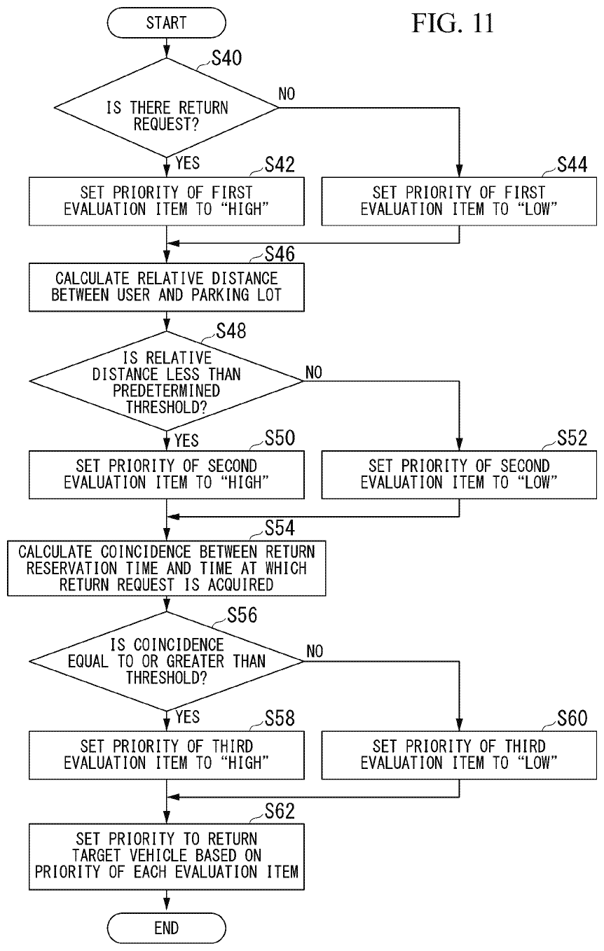

Net, a flow of a series of processes when the parking management device 400 sets priority of return target vehicles according to the embodiment will be described. FIG. 11 is a flowchart illustrating a flow of a series of processes of the parking management device 400 according to the embodiment. The processes of the flowchart are equivalent to the process of step S16 in FIG. 10.

First, the return manager 426 determines whether there is a return request of the vehicle from the parking lot (step S40). Then, when the return manager 426 determines that there is the return request of the vehicle from the parking lot, the return manager 426 sets priority of a first evaluation item to “High” with reference to the priority table 438 (step S42). Conversely, when the return manager 426 determines that there is no return request of the vehicle from the parking lot, the return manager 426 sets priority of the first evaluation item to “Low” with reference to the priority table 438 (step S44). Subsequently, the return manager 426 calculates a relative distance between the user and the parking lot (step S46). The return manager 426 determines whether the relative distance between the user and the parking lot is less than a predetermined threshold (step S48). When the return manager 426 determines that the relative distance between the user and the parking lot is less than the predetermined threshold, the return manager 426 sets priority of a second evaluation item to “High” with reference to the priority table 438 (step S50). Conversely, when the return manager 426 determines that the relative distance between the user and the parking lot is equal to or greater than the predetermined threshold, the return manager 426 sets priority of a second evaluation item to “Low” with reference to the priority table 438 (step S52). Subsequently, the return manager 426 calculates the coincidence between the return reservation time of the vehicle from the parking lot and the time at which the return of the vehicle from the parking lot is requested (step S54). The return manager 426 determines whether the coincidence between the return reservation time of the vehicle from the parking lot and the time at which the return of the vehicle from the parking lot is requested is equal to or greater than a predetermined threshold (step S56). When the return manager 426 determines that the coincidence between the return reservation time of the vehicle from the parking lot and the time at which the return of the vehicle from the parking lot is requested is equal to or greater than the predetermined threshold, the return manager 426 sets priority of a third evaluation item to “High” (step S58). Conversely, when the return manager 426 determines that the coincidence between the return reservation time of the vehicle from the parking lot and the time at which the return of the vehicle from the parking lot is requested is less than the predetermined threshold, the return manager 426 sets priority of a third evaluation item to “Low” (step S60). Then, the return manager 426 sets the priority to the return target vehicle based on the priority of each evaluation item (step S62). In this way, the process of the flowchart ends.

### [Hardware Configuration]

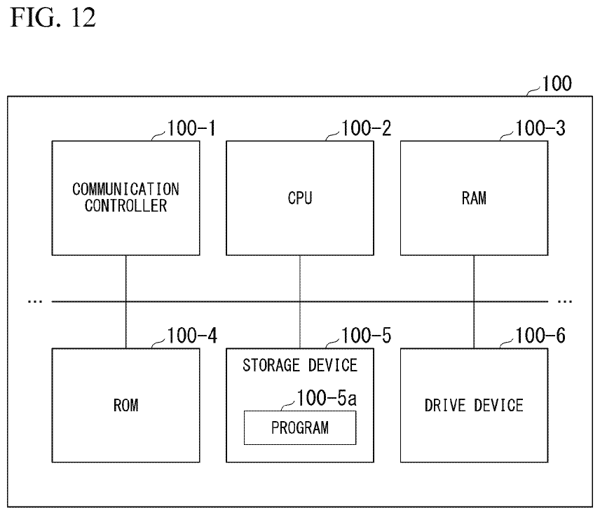

FIG. 12 is a diagram illustrating an example of a hardware configuration of an automated driving control device 100 according to an embodiment. As illustrated, the automated driving control device 100 is configured such that a communication controller 100-1, a CPU 100-2, a RAM 100-3 that is used as a working memory, a ROM 100-4 that stores a boot program or the like, a storage device 100-5 such as a flash memory or a HDD, a drive device 100-6, and the like are connected to each other via an internal bus or a dedicated communication line. The communication controller 100-1 performs communication with constituent element other than the automated driving control device 100. A portable storage medium (for example, a computer-readable non-transitory storage medium) such as an optical disc is mounted on the drive device 100-6. The storage device 100-5 stores a program 100-5a that is executed by the CPU 100-2. The program is loaded on the RAM 100-3 by a direct memory access (DMA) controller (not illustrated) to be executed by the CPU 100-2. The program 100-5a to which the CPU 100-2 refers may be stored in the portable storage medium mounted on the drive device 100-6 or may be downloaded from another device via a network. Thus, some or all of the functions of the automated driving control device 100 are realized.

The parking management device 400 according to the above-described embodiments can improve boarding efficiency of users of vehicles. For example, when the vehicles parked in the parking lot are dispatch to the boarding area 310, the user may not efficiently board the vehicles depending on the sequence of the dispatch in some cases. In the parking management device 400 according to the embodiments, however, when the number of vehicles dispatched to the boarding area 310 at the same period of time is plural, priority is set in each of the plurality of vehicles in consideration of situations of the users and the sequence of dispatch of the vehicles to the boarding area 310 from the parking lot is determined based on the set priority. Therefore, it is possible to improve boarding efficiency of the users of the vehicles.

The parking management device 400 can further improve boarding efficiency of users of vehicles. For example, when the vehicles parked in the parking lot are dispatched to the boarding area 310, boarding of the users of the vehicles may not be efficient depending on correspondence relation between the sequence of the dispatch and boarding positions of the vehicles in some cases. In the parking management device 400 according to the embodiments, however, boarding positions of the vehicles in the boarding area 310 are set in consideration of the sequence of the dispatch of the vehicles in the boarding area 310 from the parking lot. Therefore, it is possible to further improve boarding efficiency of the users of the vehicles.

The parking management device 400 can manage a usage situation of the parking lot further appropriately. For example, when a staying time of a vehicle in the boarding area 310 is long or preset reservation information of a return of a vehicle is not observed, other users are hindered from using the parking lot in some cases. In the parking management device 400 according to the embodiments, however, a penalty is imposed to the user in consideration of a usage situation of the parking lot as necessary. Therefore, it is possible to manage the usage situation of the parking lot appropriately.

The embodiments for carrying out the present invention have been described above, but the present invention is not limited to the embodiments. Various modifications and substitutions can be made within the scope of the present invention without departing from the gist of the present invention.

What is claimed is:

1. A parking management device comprising:
a communicator configured to communicate with a vehicle and a terminal device of a user of the vehicle;
a return manager configured to determine a sequence in which the vehicle arrives at a boarding area in which the user boards based on a position of the user recognized based on information acquired by the communicator, whether there is a return request of the vehicle from a parking lot which is acquired by the communicator, and coincidence between a time at which the return request of the vehicle is acquired and a return reservation time of the vehicle acquired in advance by the communicator; and
a vehicle controller configured to cause the communicator to transmit information which is used by a return target vehicle in autonomous traveling from the parking lot to the boarding area to the return target vehicle based on a sequence of the return target vehicle determined by the return manager.

2. The parking management device according to claim 1, wherein the return manager advances a sequence in which a vehicle parked in the parking lot arrives at the boarding area as the coincidence between the time at which the return request of the vehicle is acquired and the return reservation time of the vehicle acquired in advance by the communicator is higher.

3. The parking management device according to claim 1, wherein, when the return request of the vehicle from the parking lot is acquired by the communicator, the return manager advances a sequence in which the vehicle parked in the parking lot arrives at the boarding area than when the return request of the vehicle from the parking lot is not acquired by the communicator.

4. The parking management device according to claim 1, wherein the return manager advances a sequence in which the vehicle parked in the parking lot arrives at the boarding area as a relative distance between the position of the user recognized based on the information acquired by the communicator and a position of the parking lot is shorter.

5. The parking management device according to claim 1,
wherein a plurality of boarding positions are in the boarding area, and
wherein the vehicle controller causes the communicator to transmit information which is used in autonomous traveling until a first boarding position to a first vehicle of which the sequence determined by the return manager is relatively earlier and causes the communicator to transmit information which is used in autonomous traveling until a second boarding position at which it is more difficult for the user to board than at the first boarding position to a second vehicle of which the sequence determined by the return manager is relatively later.

6. The parking management device according to claim 1, wherein the vehicle controller imposes a penalty on a user of the vehicle as a staying time of the vehicle in the boarding area is longer.

7. The parking management device according to claim 1, wherein the vehicle controller causes the vehicle to perform autonomous traveling from the boarding area to the parking lot when the vehicle arriving at the boarding area is not allowed to board the user and a predetermined condition is established and imposes a penalty on a user of the vehicle as the number of times the vehicle arrives at the boarding area from the parking lot until the vehicle enters and leaves from the parking lot is larger.

8. A method of controlling a parking management device, the method causing a computer:
to communicate with a vehicle and a terminal device of a user of the vehicle;
to determine a sequence in which the vehicle arrives at a boarding area in which the user boards based on a position of the user recognized based on information acquired through communication with the vehicle or the terminal device, whether there is a return request of the vehicle from a parking lot acquired through communication with the vehicle or the terminal device, and coincidence between a time at which the return request of the vehicle is acquired and a return reservation time of the vehicle acquired in advance through communication with the vehicle or the terminal device; and
to transmit information which is used by a return target vehicle in autonomous traveling from the parking lot to the boarding area to the return target vehicle based on a determined sequence of the return target vehicle.

9. A computer-readable non-transitory storage medium that stores a program causing a computer to perform:
a process of communicating with a vehicle and a terminal device of a user of the vehicle;
a process of determining a sequence in which the vehicle arrives at a boarding area in which the user boards based on a position of the user recognized based on information acquired through communication with the vehicle or the terminal device, whether there is a return request of the vehicle from a parking lot acquired through communication with the vehicle or the terminal device, and coincidence between a time at which the return request of the vehicle is acquired and a return reservation time of the vehicle acquired in advance through communication with the vehicle or the terminal device; and
a process of transmitting information which is used by a return target vehicle in autonomous traveling from the parking lot to the boarding area to the return target vehicle based on a determined sequence of the return target vehicle.
